(19) United States
(12) Patent Application Publication
(10) Pub. No.: US 2021/0316434 A1
(43) Pub. Date: Oct. 14, 2021

(54) HAMMER TACKER

(71) Applicants: HANGZHOU UNITED TOOLS CO., LTD., Hangzhou City (CN); HANGZHOU GREAT STAR INDUSTRIAL CO., LTD., Hangzhou City (CN)

(72) Inventor: Weiyi WANG, Hangzhou City (CN)

(21) Appl. No.: 17/272,908

(22) PCT Filed: Sep. 3, 2018
(86) PCT No.: PCT/CN2018/103726

§ 371 Date: Mar. 2, 2021

(51) Int. Cl. B25C 5/11; B25C 5/16

(52) U.S. Cl. CPC B25C 5/11; B25C 5/1679

(57) ABSTRACT

The present invention provides a hammer tacker. The hammer tacker includes a handle and a head portion. A ratio of a length l of the head portion to a length L of the hammer tacker is 1/6 to 1/4, a ratio of a width w of the head portion to the length L of the hammer tacker is over 1/2, and a ratio of a weight m of the head portion to a weight M of the hammer tacker is over 1/2. The handle includes a magnesium alloy housing that is die cast in one piece. A ratio of a weight n of the magnesium alloy housing to the weight M of the hammer tacker is over 0.3, and a thickness of the magnesium alloy housing is not less than 2 mm.

### FIELD OF THE INVENTION

The present invention relates to stapling tools, and in particular, relates to a hammer tacker.

### DESCRIPTION OF THE PRIOR ART

In daily life, hammer tackers are tools that can be used for fastening thinner sheets of material to other sheets of material such as wood sheets, plastic sheets, and composite material sheet. During use, when a head portion of the hammer tacker strikes a workpiece, a firing mechanism in the hammer tacker is driven to eject and insert a staple into the workpiece.

During use of a conventional hammer tacker, the handle receives obvious shocks, and operators may feel discomfort in their hand. In addition, the structure of the hammer stacker is complex, and the assembly is complicated. Accordingly, a hammer tacker which is simple in structure and convenient in assembly and can relieve discomfort caused to the hands of the operators is desired in the related art.

### SUMMARY OF THE INVENTION

In view of the above defects, a technical problem to be solved by the present invention is to provide a hammer tacker which is simple in structure and convenient in assembly and can relieve discomfort caused to the hands of the operators.

To achieve the above objective, the present invention first provides a hammer tacker, wherein a ratio of a length l of the head portion to a length L of the hammer tacker is 1/6 to 1/4, a ratio of a width w of the head portion to the length L of the hammer tacker is over 1/2, and a ratio of a weight m of the head portion to a weight M of the hammer tacker is over 1/2.

Further, the handle includes a magnesium alloy housing that is die cast in one piece.

Further, a thickness of the magnesium alloy housing is not less than 2 mm, and a ratio of a weight n of the magnesium alloy housing to the weight M of the hammer tacker is over 0.3.

Further, the head portion includes a staple trigger, wherein the staple trigger is provided with a hole, and the staple trigger is configured to move to a direction reverse to a striking direction under the effect of a reaction force when the staple trigger comes in contact with a workpiece.

Further, the head portion includes a staple firing assembly, wherein the staple firing assembly includes a transmission assembly and a firing plate, the firing plate being provided with a hole.

Further, the transmission assembly includes a first transmission plate and a second transmission plate, wherein one end of the first transmission plate is configured to be connected to the magnesium alloy housing via a first axle, one end of the second transmission plate is configured to be connected to the magnesium alloy housing via a second axle, and the other end of the first transmission plate is configured to be connected to the other end of the second transmission plate via the second axle.

Further, one end of the first transmission plate is configured to be passable through the hole in the staple trigger, and one end of the second transmission plate is configured to be passable through the hole in the firing plate.

Further, the first transmission plate is configured to move under driving by the staple trigger, the second transmission plate is configured to move in a direction reverse to the movement of the first transmission plate, and the firing plate is configured to move in a direction facing towards the movement of the second transmission plate.

Further, the magnesium alloy housing includes an elastic member and a pressure receiving plate, wherein one end of the elastic member is configured to be connected to the pressure receiving plate, the other end of the elastic member is configured to be connected to the second transmission plate, and the elastic member is configured to come into a compressed state under driving by the second transmission plate.

Further, the handle includes a magazine, wherein the magazine is disposed in a chamber defined inside the magnesium alloy housing.

As compared with the related art, according to the present invention, by optimization of distribution of dimension and weight of the hammer tacker, during use, staples may be fired or struck into the workpiece by virtue of self-weight of the hammer tacker, which reduces use of external forces and reduces shocks caused to the handle. With respect to the magnesium alloy housing that is die cast in one piece, an magnesium alloy is a high-performance lightweight structured material, whose specific gravity is close to that of plastics. The magnesium alloy has high damping coefficient and a higher damping capacity, and has a shock-absorption capacity greater than that of an aluminum alloy and steel. When an external force acts on the magnesium alloy, stress distribution on the magnesium alloy is more uniform, and a better shock-absorption effect is achieved.

The inventive concept, specific structure and the technical effect of the present invention are further described hereinafter with reference to the accompanying drawings, for the purpose of better and sufficiently understanding the objective, features and technical effect of the present invention.

### BRIEF DESCRIPTION OF THE DRAWINGS

FIG. 1 is a perspective view of a hammer tacker according to a specific embodiment of the present invention;

FIG. 2 is a perspective internal view of a head portion of the hammer tacker according to a specific embodiment of the present invention;

FIG. 3 is a perspective internal view of the head portion of the hammer tacker according to a specific embodiment of the present invention;

FIG. 4 is a perspective view of a half portion of a housing of the hammer tacker according to a specific embodiment of the present invention;

FIG. 5 is a perspective view of a spacer plate of the hammer tacker according to a specific embodiment of the present invention;

FIG. 6 is a perspective view of a firing plate of the hammer tacker according to a specific embodiment of the present invention;

FIG. 7 is a perspective view of a magazine of the hammer tacker according to a specific embodiment of the present invention;

FIG. 8 is a perspective view of the hammer tacker before firing staples according to a specific embodiment of the present invention; and

FIG. 9 is a perspective view of the hammer tacker after firing staples according to a specific embodiment of the present invention.

### DETAILED DESCRIPTION OF THE PREFERRED EMBODIMENTS

The present invention is further described with reference to the attached drawings and specific embodiments.

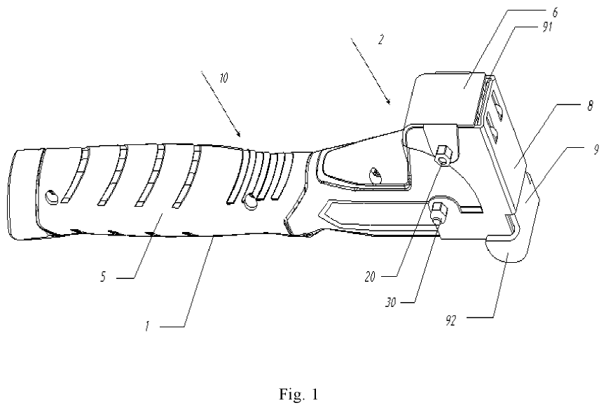

As illustrated in FIG. 1, the hammer tacker 10 includes a head portion 2 and a handle portion 1. The handle portion 1 includes a magnesium alloy housing 5 that is die cast in one piece, and the head portion 2 includes an upper cover 6, a front cover 8, and a staple trigger 9. The upper cover 6 and the front cover 8 are configured to be connected via a fastener 20, and the front cover 8 and the magnesium alloy housing 5 are configured to be connected via a fastener 30. The upper cover 6 and the front cover 8 act as a housing of the head portion 2, which packages the head portion 2 in a fastening connection fashion. The staple trigger 9 is disposed between a spacer plate 3 and the front cover 8, and the staple trigger 9 includes a bent portion 92. In this embodiment, the bent portion 92 of the staple trigger 9 is configured to strike a workpiece 100. In this embodiment, a front-most end of the head portion 2 is a front-most end of the hammer tacker 10, and a rear-most end of the handle 1 is a rear-most end of the hammer tacker 10.

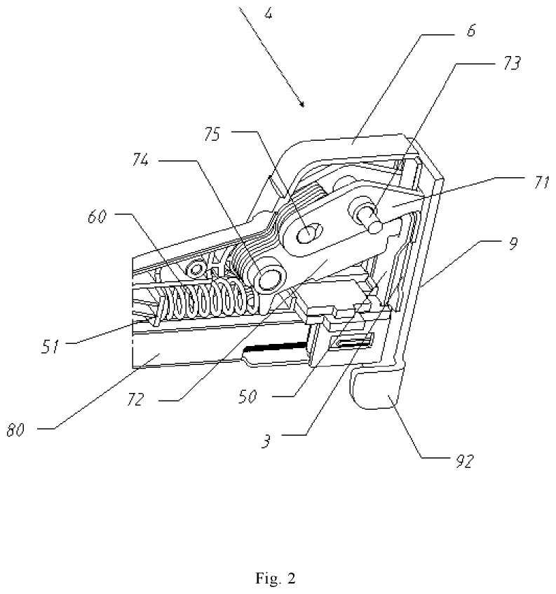

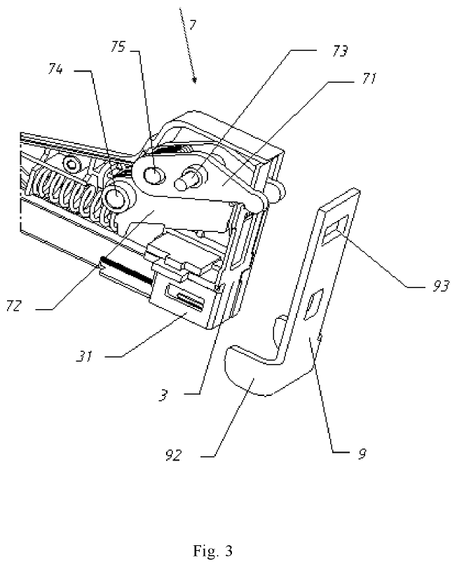

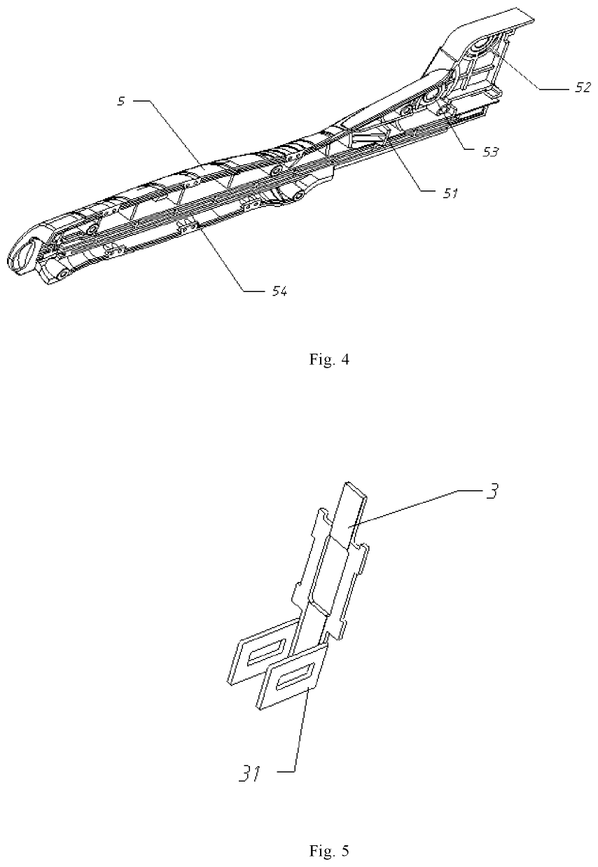

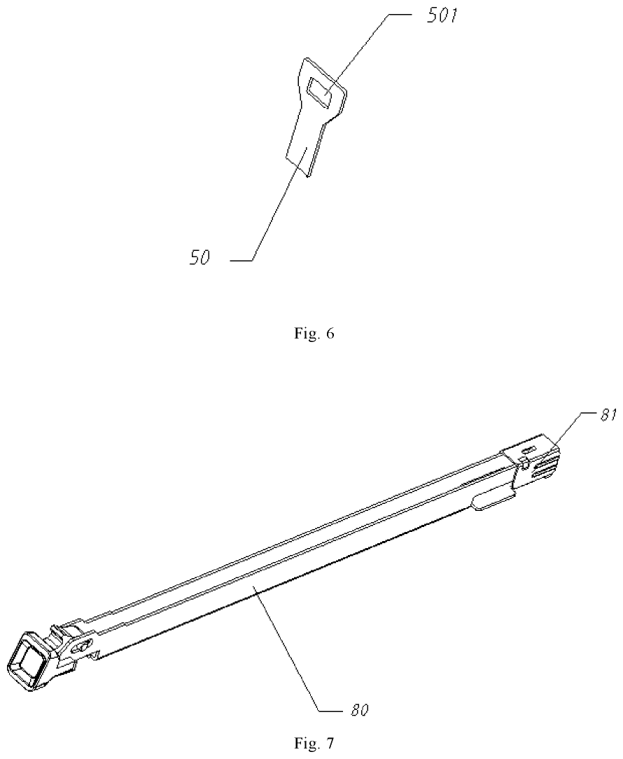

As illustrated in FIG. 2 to FIG. 6, the head portion 2 includes a staple firing assembly 4, wherein the staple firing assembly 4 includes a transmission assembly 7 and a firing plate 50. The transmission assembly 7 includes a first transmission plate 71 and a second transmission plate 72, wherein one end of the first transmission plate 71 is configured to pass through a hole 93 in the staple trigger 9, and one end of the second transmission plate 72 is configured to pass through a hole 501 in the firing plate 50. The first transmission plate 71 and the magnesium alloy housing 5 are configured to be pivotally connected via an axle 73, and the second transmission plate 72 and the magnesium alloy housing 5 are configured to be pivotally connected via an axle 74, and the first transmission plate 71 and the second transmission plate 72 are configured to be pivotally connected via a shaft 75, wherein the axle 73 and the axle 74 limits the shaft 75. During use, the first transmission plate 71 moves and drives the second transmission plate 72 to move, and the first transmission plate 71 and the second transmission plate 72 are configured to be rotatable or pivotable about the shaft 75. The axle 73 is received in a hole 52 in the magnesium alloy housing 5, and the axle 74 is received in a hole 53 in the magnesium alloy housing 5. In this embodiment, a portion of the first transmission plate 71 passing through the hole 93 in the staple trigger 9 and a portion of the second transmission plate 72 passing through the hole 501 in the firing plate 50 may be both defined to a circular shape, or may be configured to other shapes, for example, a polygonal shape or a similar shape. In this embodiment, shocks caused by use of the hammer stacker 10 may be partially transferred to the magnesium alloy housing 5 via the axle 73 and the axle 74, such that discomfort caused by the shocks may be reduced.

The elastic member 60 is disposed inside the magnesium alloy housing 5. In this embodiment, the elastic member 60 may be configured as a spring. A rear end of the elastic member 60 is configured to adjoin a pressure receiving plate 51 which is a part of the magnesium alloy housing 5, and a front end of the elastic member 60 is configured to adjoin the second transmission plate 72. In this embodiment, when the hammer tacker 10 comes in contact with the workpiece 100, the elastic member 60 undergoes effect of the second transmission plate 72, and the front end of the elastic member 60 moves towards the rear end of the elastic member 60 along a direction of a long axis of the hammer tacker 10. The firing plate 50, the spacer plate 3, and the staple trigger 9 are attached to each other in sequence, and the spacer plate 3 is fixed onto the magnesium alloy housing 5. The spacer plate 3 is integrally in an “L” shape, and a bottom end portion 31 of the spacer plate 3 is configured to receive a front end portion 81 of the magazine 80. In this embodiment, the long axis of the hammer tacker 10 starts from the front-most end of the head portion 2 and ends at the rear-most end of the handle 1, a start point-end point direction is the direction of the long axis of the hammer tacker 10, and a start point-end point spacing is a length of the long axis of the hammer tacker 10.

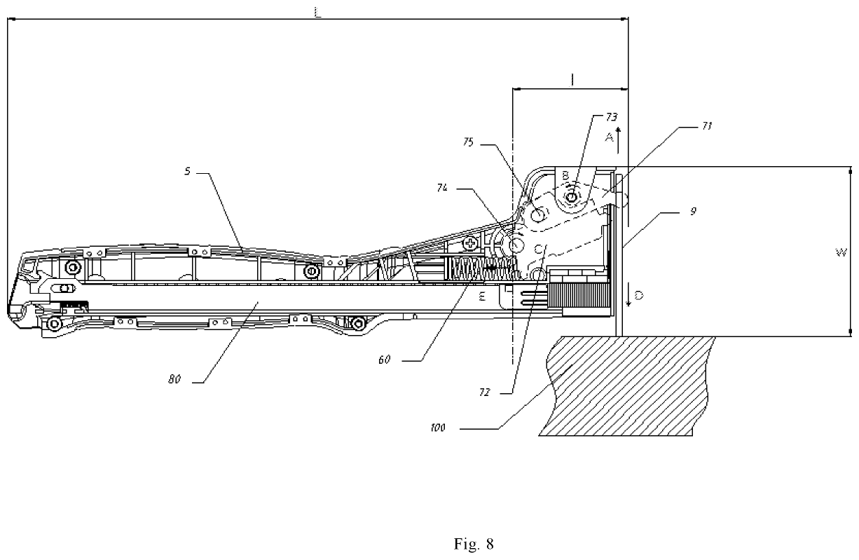

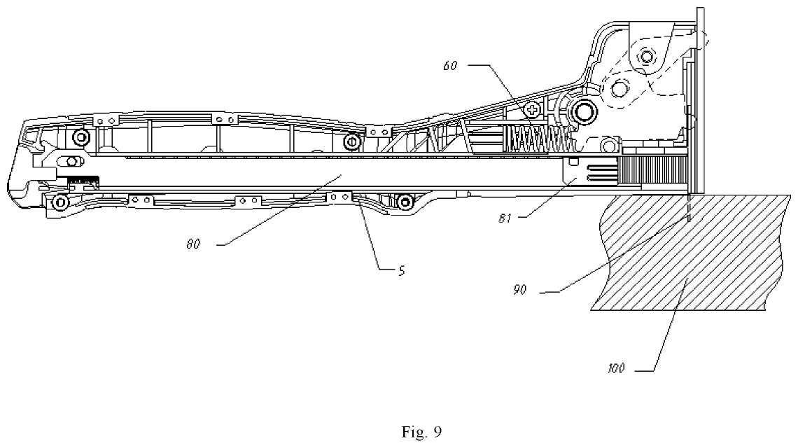

As illustrated in FIG. 7 to FIG. 9, the magazine 80 is disposed in the chamber 54 defined in the magnesium alloy housing 5. In this embodiment, the staple trigger 9 is configured to move along a direction indicated by arrow A under the effect of a reaction force when the staple trigger 9 comes in contact with the workpiece. The staple trigger 9 pushes, along the direction indicated by arrow A, the portion of the first transmission plate 71 passing through the hole 93 in the staple trigger 9, the axle 73 on the first transmission plate 71 may move along a direction indicated by arrow B, the shaft 75 moves along the same direction of the axle 73, the axle 74 on the second transmission plate 72 moves along a direction indicated by arrow C, the second transmission plate 72 moves along a direction indicated by arrow D, the front end portion of the elastic member 60, under driving by the second transmission plate 72, is deformed and compressed along a direction indicated by arrow E, the second transmission plate 72 meanwhile drives the firing plate 50 to move along the direction indicated by the arrow D, and finally a staple 90 is fired into the workpiece 100. In this embodiment, the direction indicated by arrow A is a direction reverse to a striking direction, the direction indicated by arrow B is reverse to the direction indicated by arrow C, the direction indicated by arrow D is the striking direction, and the direction indicated by arrow E is the direction of the long axis of the hammer tacker 10. In this embodiment, a length L of the hammer tacker 10 is a length of the long axis of the hammer tacker 10, which extends from the front-most end of the head portion 2 along the direction of the long axis of the hammer tacker 10, and an extension length 1 is a length of the head portion 2. A ratio of the length 1 of the head portion 2 to the length L of the hammer tacker 10 is 1/6 to 1/4, and this portion is defined as the head portion 2. When the hammer tacker 10 is not used, a distance from a bottom-most end of the bent portion 92 of the staple trigger 9 to an upper surface of the upper cover 6 is defined as a width w of the head portion 2. A ratio of the width w of the head portion 2 to the length L of the hammer tacker 10 is over 1/2. A ratio of a weight m of the head portion 2 to a weight M of the hammer tacker 10 is over 1/2. A ratio of a weight n of the magnesium alloy housing 5 to the weight M of the hammer tacker 10 is over 0.3, and a thickness of the magnesium alloy housing 5 is not less than 2 mm. By optimization of distribution of dimension and weight of the hammer tacker, during use, staples may be fired or struck into the workpiece by virtue of self-weight of the hammer tacker, which reduces use of external forces and reduces shocks caused to the handle.

Detailed above are merely exemplary embodiments for the purpose of illustrating the present invention. It should be noted that persons of ordinary skill in the art would derive various modifications or variations based on the inventive concept of the present invention without paying any creative effort. Therefore, all possible technical solutions reached by a person skilled in the art by means of logical analysis, reasoning or limited experiments or trials based on the inventive concept of the present invention and the related art shall fall within the protection scope defined by the appended claims.

1. A hammer tacker, comprising a handle and a head portion, characterized in that, a ratio of a length l of the head portion to a length L of the hammer tacker is 1/6 to 1/4, a ratio of a width w of the head portion to the length L of the hammer tacker is over 1/2, and a ratio of a weight m of the head portion to a weight M of the hammer tacker is over 1/2.

2. The hammer tacker according to claim 1, wherein the handle comprises a magnesium alloy housing that is die cast in one piece.

3. The hammer tacker according to claim 2, wherein a thickness of the magnesium alloy housing is not less than 2 mm, and a ratio of a weight n of the magnesium alloy housing to the weight M of the hammer tacker is over 0.3.

4. The hammer tacker according to claim 1, wherein the head portion comprises a staple trigger, the staple trigger being provided with a hole, and the staple trigger being configured to move to a direction reverse to a striking direction under the effect of a reaction force when the staple trigger comes in contact with a workpiece.

5. The hammer tacker according to claim 4, wherein the head portion comprises a staple firing assembly, the staple firing assembly comprising a transmission assembly and a firing plate, the firing plate being provided with a hole.

6. The hammer tacker according to claim 5, wherein the transmission assembly comprises a first transmission plate and a second transmission plate, one end of the first transmission plate being configured to be connected to the magnesium alloy housing via a first axle, one end of the second transmission plate being configured to be connected to the magnesium alloy housing via a second axle, and the other end of the first transmission plate being configured to be connected to the other end of the second transmission plate via the second axle.

7. The hammer tacker according to claim 6, wherein one end of the first transmission plate is configured to be passable through the hole in the staple trigger, and one end of the second transmission plate is configured to be passable through the hole in the firing plate.

8. The hammer tacker according to claim 7, wherein the first transmission plate is configured to move under driving by the staple trigger, the second transmission plate is configured to move in a direction reverse to the movement of the first transmission plate, and the firing plate is configured to move in a direction facing towards the movement of the second transmission plate.

9. The hammer tacker according to claim 8, wherein the magnesium alloy housing comprises an elastic member and a pressure receiving plate, one end of the elastic member being configured to be connected to the pressure receiving plate, the other end of the elastic member being configured to be connected to the second transmission plate, and the elastic member being configured to come into a compressed state under driving by the second transmission plate.

10. The hammer tacker according to claim 9, wherein the handle comprises a magazine, the magazine being disposed in a chamber defined inside the magnesium alloy housing.

11. The hammer tacker according to claim 2, wherein the head portion comprises a staple trigger, the staple trigger being provided with a hole, and the staple trigger being configured to move to a direction reverse to a striking direction under the effect of a reaction force when the staple trigger comes in contact with a workpiece.

12. The hammer tacker according to claim 11, wherein the head portion comprises a staple firing assembly, the staple firing assembly comprising a transmission assembly and a firing plate, the firing plate being provided with a hole.

13. The hammer tacker according to claim 12, wherein the transmission assembly comprises a first transmission plate and a second transmission plate, one end of the first transmission plate being configured to be connected to the magnesium alloy housing via a first axle, one end of the second transmission plate being configured to be connected to the magnesium alloy housing via a second axle, and the other end of the first transmission plate being configured to be connected to the other end of the second transmission plate via the second axle.

14. The hammer tacker according to claim 13, wherein one end of the first transmission plate is configured to be passable through the hole in the staple trigger, and one end of the second transmission plate is configured to be passable through the hole in the firing plate.

15. The hammer tacker according to claim 14, wherein the first transmission plate is configured to move under driving by the staple trigger, the second transmission plate is configured to move in a direction reverse to the movement of the first transmission plate, and the firing plate is configured to move in a direction facing towards the movement of the second transmission plate.

16. The hammer tacker according to claim 15, wherein the magnesium alloy housing comprises an elastic member and a pressure receiving plate, one end of the elastic member being configured to be connected to the pressure receiving plate, the other end of the elastic member being configured to be connected to the second transmission plate, and the elastic member being configured to come into a compressed state under driving by the second transmission plate.

17. The hammer tacker according to claim 16, wherein the handle comprises a magazine, the magazine being disposed in a chamber defined inside the magnesium alloy housing.
